(19) United States
(12) Patent Application Publication
(10) Pub. No.: US 2006/0078258 A1
(43) Pub. Date: Apr. 13, 2006

(54) Apparatus and method for trimming and tuning coupled photonic waveguides

(75) Inventors: Igor Anisimov, Dayton, OH (US); Brian G. Bagley, Bowling Green, OH (US); Robert T. Deck, Toledo, OH (US)

Correspondence Address: MACMILLAN SOBANSKI & TODD, LLC;ONE MARITIME PLAZA FOURTH FLOOR, 720 WATER STREET, TOLEDO, OH, 43604-1619, US

(73) Assignee: University of Toledo

(21) Appl. No.: 11/246,934

(22) Filed: Oct. 7, 2005

Related U.S. Application Data
(60) Provisional application No. 60/616,892, filed on Oct. 7, 2004.

(51) Int. Cl. G02B 6/26

(52) U.S. Cl. 385/50; 385/42

(57) ABSTRACT

The coupling of a pair of optical waveguides is trimmed and/or tuned in an optimal manner by alteration of the refractive index of the structure in a segment of the waveguide structure.

### CROSS-REFERENCE TO RELATED APPLICATIONS

This application claims the benefit of U.S. Provisional Application No. 60/616,892, filed Oct. 7, 2004, the disclosure of which is incorporated herein by reference.

### BACKGROUND OF THE INVENTION

This invention relates in general to photonic devices. More particularly, this invention relates to multiple channel directional couplers in planar geometry lightguide circuits used as optical power dividers, wavelength or polarization filters in photonic circuits, and a method whereby the performance of a fabricated multiple channel device can be reliably altered so as to correct, or change, the output of the device in a desired way.

Photonic integrated circuits consist of dielectric waveguide structures designed to receive, process and transmit lightwave signals. In photonic systems, optical fibers and planar waveguides replace traditional metallic conductors, and photonic integrated circuits, lasers and photodetectors replace the traditional electronic devices. Multiple channel directional couplers, for use as power dividers, wavelength filters or interferometers, represent important elements in future photonic integrated circuits as well.

Presently, current photolithographic techniques make it possible to fabricate such circuits with a high level of miniaturization on a micron or submicron scale. Some of these technologies are similar to those used in fabrication of conventional electronic integrated circuits. For example, photolithographic techniques may be used to fabricate two-dimensional waveguide geometries on a micron or submicron scale.

Because the functionality of photonic devices can be extremely sensitive to the geometric and compositional parameters of the waveguides, one of the important factors in fabricating photonic integrated circuits is the geometric tolerance. However, higher tolerances require use of more sophisticated manufacturing equipment, which significantly increases the manufacturing cost. Additionally, even such sophisticated manufacturing techniques, such as high resolution microfabrication, have limitations due to diffraction effects. Therefore, it is not always possible to make elements of photonic integrated circuits with precise geometry.

Traditionally, once a device is fabricated, it is almost impossible to change its configuration if it is tested as defective due to extraneous compositional variations or an inaccuracy in the dimensions of its elements. This is because there are very few known techniques that allow for alteration of the parameters of photonic devices, and particularly few techniques for altering optical integrated circuit devices. Additionally, those techniques that are known are generally applied to alter parameters in conventional electronic integrated circuits. Therefore, it would be advantageous to develop an improved method for altering the parameters of photonic devices, and in particular photonic integrated circuits, post fabrication.

### BRIEF SUMMARY OF THE INVENTION

This invention relates to an improved method for altering the parameters of photonic devices, in particular photonic integrated circuits, post-fabrication.

The present invention introduces a technique that can be applied to adjust the functionality of photonic devices based on multiple channel waveguides in a way that has maximum advantages. Where the process of alteration is intended to produce a fixed correction to the characteristics of the device, the alteration is referred to as trimming. Where the process is intended to produce variable changes in the output, such as changes induced by electro-optic, magneto-optic or acousto-optic effects, the alteration is referred to as tuning. In either case, the alteration in the physical properties of the waveguide can be controlled on a submicron scale. surrounds said optical channel waveguides.

The present invention contemplates an optical waveguide coupling device that includes at least two optical channel waveguides functioning as at least one of power dividing and directional coupling elements, with the energy in one channel of the device being caused to transfer to another channel after a distance of travel within said one channel that is equal to a coupling length L. The device also includes a region of perturbation of length δz in communication with said optical channel waveguides, said region of perturbation having an effective index of refraction that causes a change in said coupling length by an amount ΔL in such a way that the profile of the refractive index in the altered region is symmetric about the direction of propagation of a light signal, whereby said changed coupling length provides a method of controlling the transfer of energy between said channel waveguides.

In the preferred embodiment of the device, optical channel waveguides are planar waveguide devices that are included within a photonic integrated circuit. Furthermore, at least a portion of the optical channels may be covered by cladding material to prevent light leakage. Additionally, the region of perturbation may either surround the waveguides or extend therebetween.

The method of the invention makes use of a theoretical analysis for trimming/tuning in dielectric waveguide structures that shows that trimming/tuning can be carried out in an optimal manner by alteration of the refractive index of the structure in a segment of the structure. The refractive index of the structure is altered in such a way that the profile of the refractive index in the altered region is symmetric about the direction of the propagation of the light signal.

Accordingly, the invention also includes a method for coupling optical waveguides that includes providing a coupling device as described above and then changing the effective index of refraction of the region of perturbation to cause a change in the coupling length of the device by an amount ΔL, whereby the changed coupling length provides a method of controlling the transfer of energy between the waveguides

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a representation of a two channel directional coupler of rectangular cross section that can be formed in accordance with the method of the present invention. The directional coupler consists of two optically coupled waveguide cores a and b (cladding is not depicted) with the evanescent field of the light in each waveguide coupling to the other waveguide.

FIG. 2 is a schematic representation of the profiles of the supermodes of the directional coupler in FIG. 1, as a function of the transverse coordinate x, superimposed on the cross section of the coupler formed in accordance with the method of the present invention.

FIG. 3 illustrates a plan view of the channels of the directional coupler illustrated in FIG. 1 in which a perturbation of refractive index is located in the right channel.

FIG. 4 illustrates a plan view of the channels of the directional coupler illustrated in FIG. 1, in which equal perturbations are introduced into both channels.

FIGS. 5(a) through 5(f) illustrate plan views of the channels of the directional coupler illustrated in FIG. 1, in which perturbations of refractive index are introduced into regions external to the channels in a manner so as to maintain symmetry with respect to the long axis of the coupler consistent with the method of the present invention.

FIG. 6 illustrates the geometry of the directional coupler in a case in which the effective index of refraction of the coupler is altered in accordance with the preferred method of the present invention.

### DETAILED DESCRIPTION OF THE PREFERRED EMBODIMENT

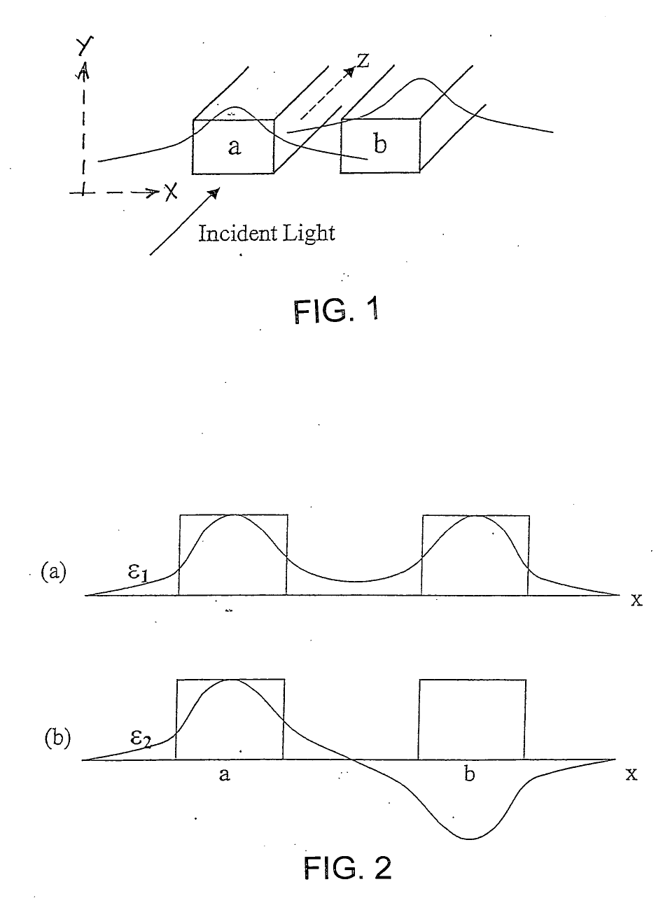

Referring now to the drawings, there is illustrated in FIG. 1 a planar lightguide device having two or more optical channels of rectangular cross-sectional shape, labeled a and b. The channels also may have other cross-sectional shapes, such as, for example a square, a circle, as in fiber optic waveguides, polygonal, triangular, oval or elliptical. The optical channels act as weakly coupled waveguides in the sense that a waveguide mode in one channel has an evanescent field in the region between the channels that penetrates into the adjacent channel. For a simple example, we choose a device consisting of two waveguides. Such a device is referred to as a directional coupler. In the operation of such a device, radiation directed into one of the channels of the coupler will exit from the other channel after a length of propagation, referred to as the coupling length, L, of the coupler, which is dependent on both the dimensions of the channels and the indices of refraction of the channels and the surrounding medium. Complete transfer of energy between the channels of the coupler can occur only in the symmetric channel case in which the two channels of the coupler are identical. In the case in which the number of channels exceeds two, the coupling length is referred to herein as the travel distance within the device after which the output has a desired character. The method of the present invention operates to adjust the coupling length of such a manufactured device so that it coincides with the designed coupling length of the device.

Given the geometrical and material parameters of a coupler generally, determination of the coupling length of the coupler requires a solution of Maxwell's equations subject to the boundary conditions at the boundaries of the channels (and at infinity). Under the condition that the dimensions of two identical channels are restricted such that each channel, in isolation, supports only a single waveguide mode, a symmetric coupler constructed from combination of the two channels supports only two supermodes characterized by electric field profiles that are symmetric and anti-symmetric, respectively, as a function of the transverse coordinate x, as depicted in FIG. 2. Specifically, FIG. 2a is a schematic representation of a symmetric supermode, and FIG. 2b is a schematic representation of an anti-symmetric supermode. Solution of Maxwell's equations for the field in the coupler as a function of z in this case leads to a formula for the coupling length L given by:

$$L = \frac{π}{{β}_{1} - {β}_{2}} , \qquad ( 1 )$$

where β₁ and β₂ denote the propagation constants of the symmetric and anti-symmetric modes at the central wavelength of the incident radiation.

It is a consequence of the rectangular geometry of the planar waveguide that an analytic solution of Maxwell's equations determining the propagation constants of the coupler can be obtained only under the condition that the dielectric function of the total structure can be approximated as a sum of separate functions of the transverse coordinates x and y in FIG. 1. Under this condition, a solution of Maxwell's equations can be found by the method of separation of variables. The necessary approximation leads to an inaccuracy in the form of the mode field functions in the outer regions of the coupler surrounding the waveguide channels, which results in an error in the computed values of the propagation constants. Corrections for this error are termed “corner corrections”. It is relevant to the present invention that, because the coupling length of the coupler is determined by the difference between the nearly equal propagation constants of the modes of the coupler, β₁ and β₂, the small errors in the values of the propagation constants resulting from the latter approximation significantly complicates the design of a coupler with a given coupling length.

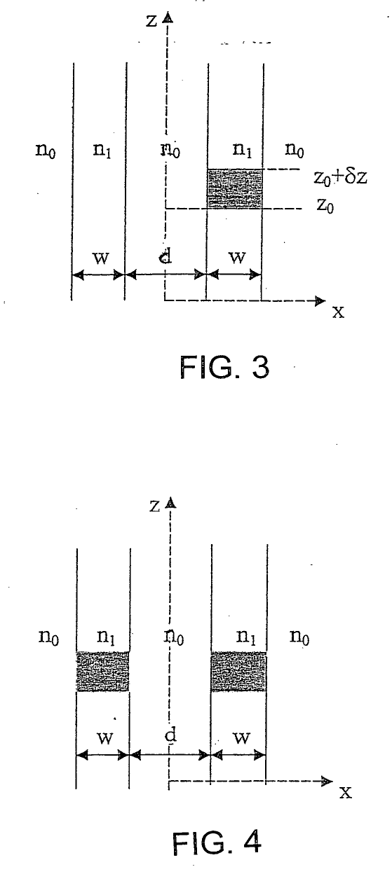

On the other hand, the existence of the equality in Eq. (1) makes it possible to adjust the coupling length of a directional coupler by a change in the propagation constants of the modes of the structure in a restricted region of the coupler. This can be accomplished by an alteration in the index of refraction of one of the channels in a short segment of the coupler of length δz, as indicated schematically (for example) in FIG. 3. FIG. 3 shows a shaded region within a segment of the coupler between coordinate values zₒ and zₒ+δz in which the index of refraction of the coupler is altered so as to result in a change in the effective index of refraction of the coupler. Such an alteration produces a change in the coupling length, which is referred to as ΔL in the following, expressible in the form:

$$Δ L = \frac{ϕ}{{β}_{1} - {β}_{2}} \qquad ( 2 )$$

where ø represents the relative change in the phase of the mode fields introduced by the change in index δn. In general, ΔL can be shown to have a (nearly) linear dependence on δn and δz, and a “sinusoidal” dependence on the coordinate, zₒ, at which the “perturbation” in the waveguiding structure initiates. The dependences on δn and δz make possible coarse changes in the structure of the coupler that result in fine changes in the coupling length, ΔL. In contrast, the periodic dependence of ΔL on zₒ increases the required precision of the trimming, so as to result in a potential inaccuracy in the value of ΔL.

It is a result of the analysis underlying the present invention that the dependence of the change in the coupling length on the value of zₒ is eliminated under the condition that the refractive index profile function in the altered region of the coupler is symmetric about the direction of propagation of the light signal. Specifically, it is shown that, under this condition, the change in the coupling length of the coupler produced by a change δn in the dielectric constant in a segment of the coupler of length δz is expressible in the form:

$$Δ L = \frac{δ z}{{β}_{1} - {β}_{2}} \frac{{ω}^{2}}{{c}^{2}} \underbrace{\int ⅆ x \int ⅆ y}_{Region of perturbation} n ( x , y ) δ n ( x , y ) [ \frac{{\tilde{ɛ}}_{2}^{2}}{{β}_{2}} - \frac{{\tilde{ɛ}}_{1}^{2}}{{β}_{1}} ] \qquad ( 3 )$$

where \tilde{ε}₁² and \tilde{ε}₂² denote the profile functions of the lowest order symmetric and anti-symmetric modes of the coupler, respectively. The linear dependence of the above expression on δn allows the sign of ΔL to be determined by the sign of the change in index, which in turn can be caused to be positive, for example, by ion implantation or made negative, for example, by laser ablated voids.

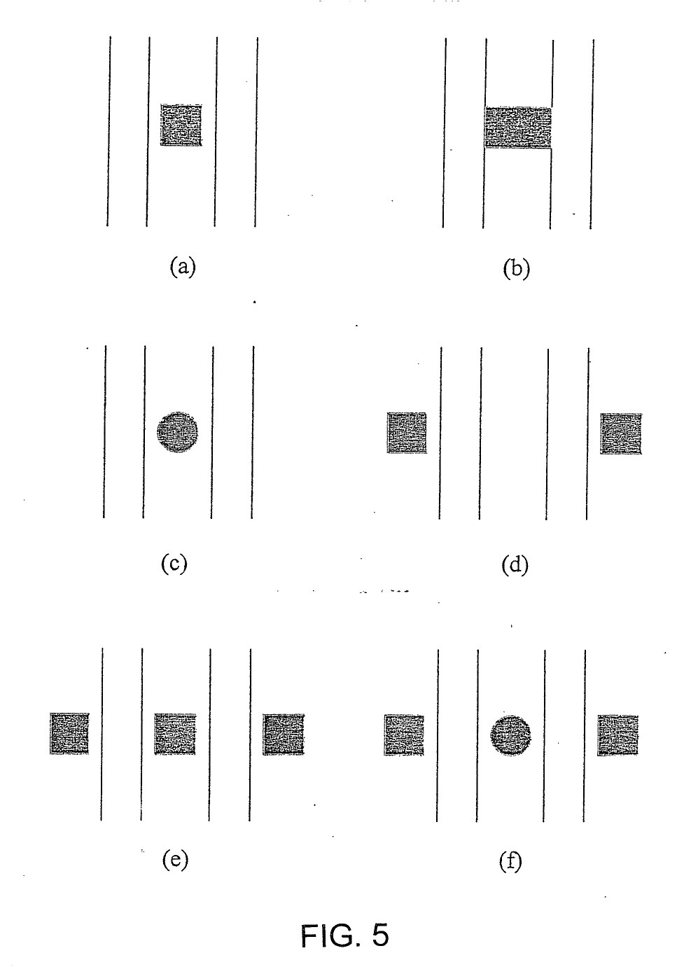

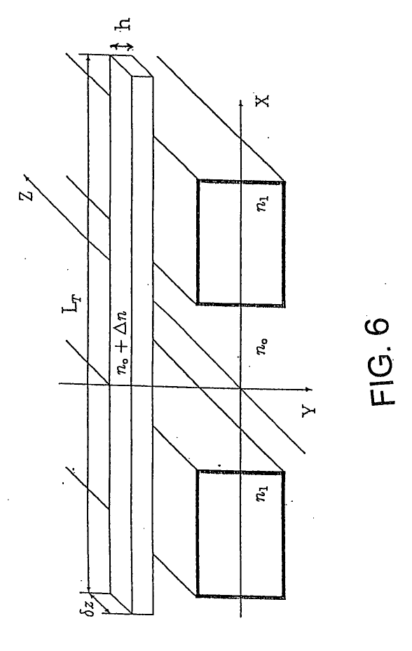

FIGS. 4, 5, and 6 show geometries in which the regions of changed refractive index have a symmetry with respect to the longitudinal bisector of the coupler that is consistent with the present invention. In FIG. 4, equal perturbations in refractive index are introduced into the interiors of both channels in a segment of the coupler of length δz. In contrast, in FIG. 5, the perturbations in refractive index are introduced into the cladding regions external to the channels in a manner so as to maintain symmetry with respect to the axes of the couplers. Compared to the geometries of FIGS. 3 and 4, the geometries of FIGS. 5 and 6 have the advantage of minimizing losses introduced by the perturbations and simultaneously allowing for implementation of more minute changes in the coupling length of the coupler.

It is an important characteristic of a useful method of trimming/tuning that the precision needed in the changes in the coupler structure be reduced to a minimum. It is a key element of the present invention that the procedure for the trimming/tuning of a directional coupler satisfies this requirement. The general features of the invention proposed here can be extracted from the diagram in FIG. 6 (cladding not shown). In detail, the invention defines a method of trimming/tuning in which a change in the index of refraction of the coupler is produced in a region of index n and length δz by fabrication of a strip of refractive index n+δn transverse to the direction of propagation of the light and at a distance Δ above (or below) the channels of the coupler. In a preferred embodiment, Δ is taken to equal zero. In this geometry, under the condition that the transverse length L_{T} and vertical thickness h of the strip are sufficiently large so as to exceed the decay lengths of the evanescent fields of the coupler in the x and y directions, the effective index of refraction of the coupler in the region of length δz is independent of both L_{T} and h, and is symmetric about the direction of propagation of the light signal (so as to be simultaneously independent of zₒ). It follows that the design requirements for the region of perturbation in the arrangement diagrammed in FIG. 6 are less stringent then those in the arrangement diagrammed in FIGS. 3 through 5.

The method of the present invention focuses specifically on the trimming/tuning of a rectangular geometry directional coupler, here taken to represent the basic element of a planar lightwave circuit. Techniques for altering the properties of a waveguide by ion implantation or laser induced changes in the index of refraction of a section of the guiding region presently exist; however, the method of the present invention creates a connection between a micron scale change in the properties of a directional coupler and the coupling length that defines the device.

The method of the present invention makes use of two different formulations of the theory underlying an evaluation of the change in the coupling length of a coupler produced by a change in the index of refraction of a segment of the coupler. First, the case of a planar geometry directional coupler consisting of two identical parallel rectangular channels, labeled a and b, respectively, in FIGS. 1 and 2, is analyzed.

When radiation is directed into one of the channels, complete transfer of energy between the two channels can occur only in the symmetric coupler case in which the two channels of the coupler are identical. In this case the coupling length L can be shown to be given by the formula in Eq. (1).

The interest is in an adjustment of the coupling length of a symmetric coupler with a “measured” coupling length L₀. This can be done by a change in the propagation constants of the guided modes of the coupler; which is made possible by an alteration in the properties of one (or both) of the channels in a restricted region of the coupler. Here we consider the case in which the index of refraction of the coupler is changed in a segment of the coupler along the effective direction of propagation of length δz.

The propagation of an electromagnetic field of central frequency ω in a directional coupler is determined by Maxwell's equations, which (after neglect of a term ∇ (∇.E)) combine into a wave equation for the Fourier amplitude of the electric field E(r, ω) expressible in Gaussian units as

$$[ {∇}^{2} + \frac{{ω}^{2}}{{c}^{2}} ɛ ( x , y , z ) ] E ( r , ω ) = 0 \qquad ( 4 )$$

A general solution of Eq. (4) corresponding to guided propagation in the z direction is expressible as a linear combination of the waveguide modes of the total structure. These “supermodes” are determined by the dielectric functions ε′(x,y) and ε (x,y), inside and outside the region z₀<z<z₀+δz respectively, by way of the equations:

$$\begin{matrix}E ( r , ω ) = {\sum }_{l}^{} {a}_{l}^{′} {ɛ}_{l}^{′} ( x , y ) {ⅇ}^{i {β}_{l}^{′} z} , \\ z in interval {z}_{0} < z < {z}_{0} + δ z & ( 5 ) \\ E ( r , ω ) = {\sum }_{l}^{} {a}_{l} {ɛ}_{l} ( x , y ) {ⅇ}^{i {β}_{l} z} , \\ z \underline{not} in interval {z}_{0} < z < {z}_{0} + δ z & ( 6 )\end{matrix}$$

where εₗ(x, y) and ε′ₗ(x, y) represent the transverse profiles of the the l^{th} supermodes, defined by the equation

$$[ \frac{{\partial }^{2} }{\partial {x}^{2}} + \frac{{\partial }^{2} }{\partial {y}_{2}} + \frac{{ω}^{2}}{{c}^{2}} ɛ ( x , y ) - {β}_{l}^{2} ] {ɛ}_{l} ( x , y ) = 0 \qquad ( 7 )$$

and a similar equation with εₗ and βₗ replaced by ε′ₗ and β′ₗ, and βₗ and β′ₗ are the propagation constants of the l^{th} modes in the distinct regions of z. It is a consequence of the orthogonality of the distinct solutions of the differential Eq. (7) that the functions ε′ₗ(x,y) and εₗ(x, Y) satisfy orthogonality relations, which we choose to express in the form

$${\int }_{- ∞}^{∞} ⅆ x {\int }_{- ∞}^{∞} ⅆ y {\tilde{ɛ}}_{l} ( x , y ) {\tilde{ɛ}}_{{l}^{′}} ( x , y ) = {\int }_{- ∞}^{∞} ⅆ x {\int }_{- ∞}^{∞} ⅆ y {\tilde{ɛ}}_{l}^{′} ( x , y ) {\tilde{ɛ}}_{{l}^{′}}^{′} ( x , y ) = {δ}_{{ll}^{′}} \qquad ( 8 )$$

(indicated by a tilde symbol above εₗ and ε′ₗ). What is of interest is the change in the coupling length of the directional coupler produced by a change in the dielectric constant in a section of the coupler between z₀ and z₀+δz. To determine this, it is useful to reconstruct the formula for the coupling length of a symmetric two-channel coupler. Focusing on the practical case in which the channels of the coupler each support only a single mode, the constraints imposed by the symmetry of the symmetric coupler require the two supermodes of the total structure to correspond to symmetric and anti-symmetric profile functions \tilde{ε}ₗ(x,y) and \tilde{ε}₂(x,y). As a consequence of their symmetry, the addition of the profile functions \tilde{ε}₁ and \tilde{ε}₂ results in a field that is identically zero in channel b, whereas the subtraction of \tilde{ε}₁ and \tilde{ε}₂ results in a field identically zero in channel a. Therefore, under the condition of an incident field E(x,y,z=0,ω) at z=0, that is exclusively in channel a, the electric field function at z=0 must be an equal combination of the profile functions \tilde{ε}₁ and \tilde{ε}₂, expressible as:
E(x,y,z=0,ω)=a₁(0)[\tilde{ε}₁(x,y)+\tilde{ε}₂(x,y)] (9)
where the coefficient a₁(0) is determined by the orthogonality relation in Eq. (8) through the equation:

$${a}_{1} ( 0 ) = {\int }_{- ∞}^{∞} ⅆ x {\int }_{- ∞}^{∞} ⅆ y {\tilde{ɛ}}_{1} ( x , y ) E ( x , y , z = 0 , ω ) \qquad ( 10 )$$

Use of Eq. (6) then determines the field at z=z in a form which is re-expressible as:
E(x,y,z,ω)=a₁(0)e^{iβ}^{₂}^{z}[\tilde{ε}₁(x,y)e^{i(β}^{₁}^{-β}^{₂}^{)z}+\tilde{ε}₂(x,y)] (11)
From this it follows that, at the value of z=L for which (β₁-β₂)L=π, E(x,y,z,ω) has the value:
E(x,y,L,ω)=a₁(0)e^{iβ}^{₂}^{L}[−\tilde{ε}₁(x,y)+\tilde{ε}₂(x,y)] (12)
corresponding to a field localized exclusively in channel b. The result determines (by definition) the coupling length L through the formula in Eq. (1).

In the different case here of a trimmed coupler, the latter formula is expected to be changed by the shifted phase of the coefficients of the two supermodes resulting from the change in the dielectric constant in the region between z₀ and z₀+δz. To evaluate this shift in phase, we use Eq. (5) to expand the field in the coupler between z₀ and z₀+δz in terms of the two supermodes in the region of altered dielectric constant ε′(x,y), with the coefficients a′ⱼ(zₒ) found by use of Eqs. (8) and (11) as:

$$\begin{matrix}\begin{matrix}{a}_{j}^{′} ( {z}_{o} ) = {\int }_{- ∞}^{∞} ⅆ x {\int }_{- ∞}^{∞} ⅆ y {\tilde{ɛ}}_{j}^{′} ( x , y ) E ( x , y , {z}_{o} , ω ) {ⅇ}^{- i {β}_{j}^{′} {z}_{o}} \\ = {a}_{1} ( 0 ) [ {κ}_{j1} {ⅇ}^{i ( {β}_{1} - {β}_{j}^{′} ) {z}_{o}} + {κ}_{j2} {ⅇ}^{i ( {β}_{2} - {β}_{j}^{′} ) {z}_{o}} ] , ( j = 1 , 2 )\end{matrix} \\ where & ( 13 ) \\ {κ}_{ji} ≡ {\int }_{- ∞}^{∞} ⅆ x {\int }_{- ∞}^{∞} ⅆ y {\tilde{ɛ}}_{j}^{′} ( x , y ) {\tilde{ɛ}}_{i} ( x , y ) & ( 14 )\end{matrix}$$

Equation (5) determines the field at z=z₀+δz in the form:
E(x,y,zₒ+δz,ω)=[a′₁(zₒ)\tilde{ε}′₁(x,y)e^{iβ′}^{₁}⁽z^{ₒ}+δz)
+a′₂(zₒ)\tilde{ε}′₂(x,y)e^{iβ′}^{₂}^{(z}^{ₒ}^{+εz)}] (15)
Use of Eq. (5) and the above form for E(x, y, z₀+z,ω) then makes it possible to express the field for z>z₀+δz as:
E(x,y,zω)=a₁\tilde{ε}₁(x,y)e^{iβ}^{₁}^{x}a₂\tilde{ε}₂(x,y,z)e^{iβ}^{₂}^{z},z>zₒ+δz (16)
where the orthogonality relation (δz) and Eq. (13) determine the coefficients a₁ and a₂ through the explicit formulas:
a₁=a₁(0)[K₁₂+K₁₂e^{i(β}^{₂}^{-β}^{₁}^{)z}^{ₒ}]K₁₁e^{i(β′}^{₁}^{-β}^{₁}^{)δ}z
+a₁(0)[K₂₁+K₂₂e^{i(β}^{₂}-β^{₁}^{)z}^{ₒ}]K₂₁e^{i(β′}^{₂}^{-β}^{₁}^{)δz} (17.a)
a₂=a₁(0)[K₁₁e^{i(β}^{₁}^{β}^{₂}⁾z^{ₒ}+K₁₂]K₁₂e^{i(β′}^{₁}^{-β}^{₂}^{)δz}
+a₁(0)[K₂₁e^{i(β}^{₁}^{-β}^{₂}^{)z}^{ₒ}+K₂₂]K₂₂e^{i(β′}^{₂}^{-β}^{₂}^{)δz} (17.b)

To compare the field in Eq. (16) with the field in Eq. (11) for z>zₒ+δz derived from the field at z=0 in the absence of the change in the dielectric constant in the region between z and z₀+δz, it is useful to rewrite Eq. (16) as:

$$E ( x , y , z ) = {a}_{2} {ⅇ}^{ⅈ {β}_{2} z} [ \frac{{a}_{1}}{{a}_{2}} {ⅇ}^{ⅈ ( {β}_{1} - {β}_{2} ) z} {\tilde{ɛ}}_{1} ( x , y ) + {\tilde{ɛ}}_{2} ( x , y ) ] , z > {z}_{o} + δ z \qquad ( 18 )$$

Comparison of Eqs. (11) and (18) shows that the phase difference between the superimposed mode fields introduced by the perturbation is represented by the phase ø of the factor a₁/a₂, defined by the equation:

$$\begin{matrix}\frac{{a}_{1}}{{a}_{2}} ≡ {ρⅇ}^{i ϕ} with \text{:} & ( 19 ) \\ ρ = \sqrt{{( Re [ {a}_{1} / {a}_{2} ] )}^{2} + {( Im [ {a}_{1} / {a}_{2} ] )}^{2}} , \\ ϕ = {tan}^{- 1} ( \frac{Im [ {a}_{1} / {a}_{2} ]}{Re [ {a}_{1} / {a}_{2} ]} ) & ( 20 )\end{matrix}$$

Evaluation of the phase ø given by Eq .(20) is simplified by use of relations between the coefficients kᵢⱼ that follow from the orthogonality and “completeness” relations satisfied by the separate sets of profile functions \tilde{ε}ₗ(x,y) and \tilde{ε}′ₗ(x,y), and from the assumption that the total field in the coupler at the points z₀ and z₀+δz can be expanded in either of the sets of profile functions. The latter assumption is equivalent to the assumption that the primed and unprimed profile functions can be expanded in terms of the unprimed and primed functions respectively, and it is then a consequence of the orthonormality relations (δz) that the expansions must have the forms:

$$\begin{matrix}{\tilde{ɛ}}_{l} ( x , y ) = {Σ}_{j} {κ}_{jl} {\tilde{ɛ}}_{j}^{′} ( x , y ) & ( 21. a ) \\ {\tilde{ɛ}}_{l}^{′} ( x , y ) = {Σ}_{j} {κ}_{jl}^{′} {\tilde{ɛ}}_{j} ( x , y ) & ( 21. b )\end{matrix}$$

with kjl defined by Eq. (14) and k′ⱼₗ=kₗⱼ. The explicit relations between the coefficients kᵢⱼ for i,j=1,2 are derived most simply from the matrix representations of Eqs. (21) expressible as:

$$\begin{matrix}( \begin{matrix}{\tilde{ɛ}}_{1} \\ {\tilde{ɛ}}_{2}\end{matrix} ) = ( \begin{matrix}{κ}_{11} & {κ}_{21} \\ {κ}_{12} & {κ}_{22}\end{matrix} ) ( \begin{matrix}{\tilde{ɛ}}_{1}^{′} \\ {\tilde{ɛ}}_{2}^{′}\end{matrix} ) ≡ {K}^{T} ( \begin{matrix}{\tilde{ɛ}}_{1}^{′} \\ {\tilde{ɛ}}_{2}^{′}\end{matrix} ) & ( 22. a ) \\ ( \begin{matrix}{\tilde{ɛ}}_{1}^{′} \\ {\tilde{ɛ}}_{2}^{′}\end{matrix} ) = ( \begin{matrix}{κ}_{11} & {κ}_{12} \\ {κ}_{21} & {κ}_{22}\end{matrix} ) ( \begin{matrix}{\tilde{ɛ}}_{1} \\ {\tilde{ɛ}}_{2}\end{matrix} ) ≡ K ( \begin{matrix}{\tilde{ɛ}}_{1} \\ {\tilde{ɛ}}_{2}\end{matrix} ) & ( 22. b )\end{matrix}$$

where K^{T} denotes the transpose of the matrix K. In particular, combination of the above two matrix equations produces the equalities:

$${K}^{T} K = ( \begin{matrix}{κ}_{11} & {κ}_{21} \\ {κ}_{12} & {κ}_{22}\end{matrix} ) ( \begin{matrix}{κ}_{11} & {κ}_{12} \\ {κ}_{21} & {κ}_{22}\end{matrix} ) = I = ( \begin{matrix}1 & 0 \\ 0 & 1\end{matrix} ) = {KK}^{T} \qquad ( 23 )$$

equivalent to a set of four equations for the four coefficients kᵢⱼ(i,j=1,2), which have solutions in either of the forms:
K₁₁=K₂₂,K₂₁=−K₁₂ (24.a)
K₁₁=−K₂₂,K₂₁=K₁₂ (24.b)
both of which lead to an identical result for the phase ø in Eq. (20). To obtain the result it is useful to extract the phase factor exp{i[(β′₁-β′₂)-(β₁-β₂)]δz} from the ratio a₁/a₂to re-express a₁/a₂as:

$$\frac{{a}_{1}}{{a}_{2}} = {ρⅇ}^{i ϕ} = ( \frac{{ρ}_{1} {ⅇ}^{i {ϕ}_{1}}}{{ρ}_{2} {ⅇ}^{i {ϕ}_{2}}} ) {ⅇ}^{i [ ( {β}_{1}^{′} - {β}_{2}^{′} ) - ( {β}_{1} - {β}_{2} ) ] δ z} \qquad ( 25 )$$

where ρ₁e^{iø}^{₁} and ρ₂e^{iø}^{₂} are determined by use of Eqs.(17), (24) and (25) as:
ρ₁e^{iø}^{₁}=K₁₁²+K₁₁K₁₂(1-e^{i(β′}^{₂}^{-β′}^{₁}^{)δz})e^{i(β}^{₂}^{-β}^{₁}^{)z}^{ₒ}+K₁₂²e^{i(β′}^{₂}^{-β′}^{₁}^{2)δz} (26.a)
ρ₂e^{iø}^{₂}=K₁₁²−K₁₁K₁₂(1-e^{i(β′}^{₁}^{-β′}^{₂}^{)δz})e^{i(β}^{₁}^{-β}^{₂}^{)z}^{ₒ}+K₁₂²e^{i(β′}^{₁}^{-β′}^{₂}^{2)δz} (26.b)

Use of the definitions in Eqs. (19) and (20), (along with the reality of the integrals kᵢⱼ) makes it possible to determine explicit formulas for the phases ø₁ and ø₂. By combination of Eqs. (18) and (25), the field beyond the altered region in the trimmed coupler can then be written:
E(x,y,z)=a₂e^{iβ}^{₂}^{z}[ρe^{iø}e^{i(β}^{₁}^{-β}^{₂}^{)z}\tilde{ε}₁(x,y)+\tilde{ε}₂(x,y)] (27)
with øexpressed in terms of the phases ø₁ and ø₂ as:
ø=ø₁-ø₂+[(β′₁-β′₂)-(β₁-β₂)]^{δz} (28)
It follows from Eq. (27) that destructive interference between the mode fields in channel a is a maximum under the condition that the product of phase factors e^{iø}e^{i(β}^{₁}^{-β}^{₂}^{)z} is equal to −1. The condition determines a z-value defining the coupling length L′ of the trimmed coupler through the equation:

$${L}^{′} = \frac{π - ϕ}{( {β}_{1} - {β}_{2} )} \qquad ( 29 )$$

At this value of z, the fraction of the incident energy transferred to channel b is determined by the magnitude of ρ, which, for a sufficiently weak perturbation is only slightly less than the value unity required for complete transfer of power between channels a and b.

Evaluation of L′ by use of Eq. (29) is complicated by the need to evaluate the profile finctions and propagation constants in both the trimmed and untrimmed regions of the coupler. It is therefore useful to derive a formula for the coupling length of the trinuned coupler by a different method. Here, the assumption that the dielectric constant of the unperturbed coupler, ε₀(x,y), changes in the region between z₀ and z₀+δz by an amount that is small in comparison to ε₀(x,y) makes it possible to use perturbation theory. For this purpose, it is necessary to express the dielectric function of the total structure for all z as the sum of the dielectric function of the structure in the absence of the inhomogeneity, ε₀(x,y), plus a correction term, Δε(x,y,z), that is nonzero only in the region between z₀ and z₀+δz. Explicitly, the formula is written:
ε(x,y,z)=ε_{O}(x,y)+Δε(x,y,z) (30)
where:
Δε(x,y,z)<<ε_{O}(x,y) (31)

In general, a solution of Maxwell's equations for the field in the perturbed coupler, for all z, can be expressed as a linear combination of the waveguide modes of the unperturbed structure in the form in Eq. (6), where the normalized profile functions \tilde{ε}ₗ(x,y) satisfy the equation:

$$[ \frac{{\partial }^{2}}{\partial {x}^{2}} + \frac{{\partial }^{2}}{\partial {y}^{2}} + \frac{{ω}^{2}}{{c}^{2}} {ɛ}_{o} ( x , y ) - {β}_{l}^{2} ] {\tilde{ɛ}}_{l} ( x , y ) = 0 \qquad ( 32 )$$

and the coefficients αₗ are dependent on z as a result of the z dependence of ε. Insertion of Eq. (6) into Eq. (4) with ε(x,y,z) in the form (30) produces an equation for the left hand side of Eq. (4) that Eq. (32) reduces to:

$${Σ}_{l} {\tilde{ɛ}}_{l} ( x , y ) {ⅇ}^{i {β}_{l} z} [ \frac{{ⅆ}^{2} }{ⅆ {z}^{2}} + 2 i {β}_{l} \frac{ⅆ}{ⅆ z} + \frac{{ω}^{2}}{{c}^{2}} Δɛ ( x , y , z ) ] {a}_{l} ( z ) = 0 \qquad ( 33 )$$

Scalar multiplication of this equation by εⱼ(x,y)e^{-iβjz} and integration of the result over all x and y by use of Eq. (δz) re-expresses Eq. (33) as a set of equations for the coefficients aj(z) in the form:

$$[ \frac{{ⅆ}^{2}}{ⅆ {z}^{2}} + 2 i {β}_{j} \frac{ⅆ}{ⅆ z} ] {a}_{j} ( z ) = - {Σ}_{l} {K}_{jl} {ⅇ}^{i ( {β}_{l} - {β}_{j} ) z} {a}_{l} ( z ) ≡ - {ϕ}_{j} ( z ) \qquad ( 34 )$$

with Kⱼₗ defined by the relation:

$$\begin{matrix}{K}_{jl} ≡ \frac{{ω}^{2}}{{c}^{2}} {\int }_{- ∞}^{∞} ⅆ x {\int }_{- ∞}^{∞} ⅆ y Δɛ ( x , y , z ) {\tilde{ɛ}}_{j} ( x , y ) {\tilde{ɛ}}_{l} ( x , y ) = {K}_{lj} \\ and \text{:} & ( 35 ) \\ {ϕ}_{j} ( z ) ≡ {Σ}_{l} {K}_{jl} {ⅇ}^{i ( {β}_{l} - {β}_{j} ) z} {a}_{l} ( z ) & ( 36 )\end{matrix}$$

A formal solution of Eq. (34) can be written in the form:

$${a}_{j} ( z ) = {A}_{j} + {B}_{j} {ⅇ}^{- 2 {ⅈβ}_{j} z} + \frac{ⅈ}{2 {β}_{j}} {\int }_{0}^{z} {ϕ}_{j} ( {z}^{′} ) ⅆ {z}^{′} - \frac{ⅈ}{2 {β}_{j}} {ⅇ}^{- 2 {ⅈβ}_{j} z} {\int }_{0}^{z} {ϕ}_{j} ( {z}^{′} ) {ⅇ}^{2 {ⅈβ}_{j} {z}^{′}} ⅆ {z}^{′} \qquad ( 37 )$$

where the constants Aj and Bj are related to the initial values of aj(z) and

$$\frac{ⅆ {a}_{j}}{ⅆ z}$$

through the equations:

$${{a}_{j} ( 0 ) = {A}_{j} + {B}_{j} , \frac{ⅆ j}{ⅆ z} \vert}_{z = 0} = - 2 i {β}_{j} {B}_{j} \qquad ( 38 )$$

Comparison of the solution represented by Eq. (37) with the solution of Eq. (34) in the absence of the second derivative term, expressible as:

$${a}_{j} ( z ) = {A}_{j} + \frac{ⅈ}{2 {β}_{j}} {\int }_{0}^{z} {ϕ}_{j} ( {z}^{′} ) ⅆ {z}^{′} \qquad ( 39 )$$

(where Aj=aj(0)) indicates that the second derivative term in Eq. (34) contributes to the general solution of the equation the two terms, Bj e^{-2iβjz} and

$$- \frac{ⅈ}{2 {β}_{j}} {ⅇ}^{- 2 {ⅈβ}_{j} z} {\int }_{0}^{z} {ⅇ}^{2 {ⅈβ}_{j} {z}^{′}} {ϕ}_{j} ( {z}^{′} ) ⅆ {z}^{′} ,$$

both of which are interpretable in terms of modes propagating in the negative z-direction as the result of reflection at the discrete step in the function ε(x,y,z). In the case of a “weak perturbation”, defined by the inequality Eq. (31), it is in general possible to neglect the reflection of the incident modes produced by the perturbation. The approximation is equivalent to the assumption that the mode amplitudes vary slowly in space on the length scales determined by the reciprocals of the mode propagation constants βj, consistent with the fact that the second derivative of aj(z) is small compared to the product of βj and the first derivative of aj(z). The assumption permits the neglect of the second derivative term on the left side of Eq. (34) compared to the first derivative term, to reduce the equation to the form:

$$\frac{ⅆ {a}_{j} ( z )}{ⅆ z} = \frac{ⅈ}{2 {β}_{j}} {ϕ}_{j} ( z ) = \frac{ⅈ}{2 {β}_{j}} {\sum }_{ℓ} {K}_{jℓ} {ⅇ}^{ⅈ ( {β}_{ℓ} - {β}_{j} ) z} {a}_{ℓ} ( z ) \qquad ( 40 )$$

The restriction to single mode channels then converts this last equation to a set of coupled equations for the two amplitudes a₁(z), a₂(z) expressible as:

$$\begin{matrix}2 {β}_{1} \frac{ⅆ {a}_{1} ( z )}{ⅆ z} = {ⅈK}_{11} ( z ) {a}_{1} ( z ) + {ⅈK}_{12} ( z ) {ⅇ}^{ⅈ ( {β}_{2} - {β}_{1} ) z} {a}_{2} ( z ) & ( 41. a ) \\ 2 {β}_{2} \frac{ⅆ {a}_{1} ( z )}{ⅆ z} = {ⅈK}_{22} ( z ) {a}_{2} ( z ) + {ⅈK}_{21} ( z ) {ⅇ}^{ⅈ ( {β}_{2} - {β}_{1} ) z} {a}_{1} ( z ) & ( 41. b )\end{matrix}$$

It is significant that the z-dependence of the amplitudes of the supermodes derives strictly from the perturbation. From the assumption that the perturbation is non-zero only for values of z within the interval between z₀ and z₀+δz, it follows that a₁ and a₂ are independent of z outside this interval. Below, it is assumed that Δε(x,y,z) has the z-independent value δε(x,y) within the interval z₀≦z≦z₀+δz, consistent with the equations:

$$\begin{matrix}Δɛ ( x , y , z ) = \{ \begin{matrix}δɛ ( x , y ) , & {z}_{o} \leq z \leq {z}_{o} + δ z \\ 0 , & otherwise\end{matrix} & ( 42 ) \\ {K}_{ij} ( z ) = \{ \begin{matrix}{C}_{ij} , & {z}_{o} \leq z \leq {z}_{o} + δ z \\ 0 , & otherwise\end{matrix} \\ where \text{:} & ( 43 ) \\ {C}_{ij} = \frac{{ω}^{2}}{{c}^{2}} \underbrace{\int ⅆ x \int ⅆ y}_{Region of perturbation} δɛ ( x , y ) {\tilde{ɛ}}_{i} ( x , y ) {\tilde{ɛ}}_{j} ( x , y ) = {C}_{ji} & ( 44 )\end{matrix}$$

Direct integration of Eqs. (41) over z from 0 to z, and use of Eq. (43), produces a formal solution of the equations for the amplitudes aₙ expressible as:

$$\begin{matrix}{a}_{1} ( z ) = \{ \begin{matrix}{a}_{1} ( 0 ) + \frac{ⅈ}{2 {β}_{1}} [ {\int }_{{z}_{o}}^{z} {K}_{11} ( {z}^{′} ) {a}_{1} ( {z}^{′} ) ⅆ {z}^{′} + {\int }_{{z}_{o}}^{z} {K}_{12} ( {z}^{′} ) {ⅇ}^{- {ⅈΔβz}^{′}} {a}_{2} ( {z}^{′} ) ⅆ {z}^{′} ] , & z > {z}_{o} \\ {a}_{1} ( 0 ) , & z \leq {z}_{o}\end{matrix} & ( 45. a ) \\ {a}_{2} ( z ) = \{ \begin{matrix}{a}_{2} ( 0 ) + \frac{ⅈ}{2 {β}_{2}} [ {\int }_{{z}_{o}}^{z} {K}_{22} ( {z}^{′} ) {a}_{2} ( {z}^{′} ) ⅆ {z}^{′} + {\int }_{{z}_{o}}^{z} {K}_{21} ( {z}^{′} ) {ⅇ}^{- {ⅈΔβz}^{′}} {a}_{1} ( {z}^{′} ) ⅆ {z}^{′} ] , & z > {z}_{o} \\ {a}_{2} ( 0 ) , & z \leq {z}_{o}\end{matrix} & ( 45. b )\end{matrix}$$

with Δβ≡β₁-β₂. Under the assumption that the perturbation produces only a small modification of the waveguide structure, the magnitudes of the amplitudes a₁ and a₂ can be expected to vary only slightly from their unperturbed values at z=0. This makes it possible to approximate Eqs. (45) by replacement of a₁(z) and a₂(z) in the terms proportional to δε on the right sides of these equations by the initial values . a₁(0) and a₂(0). This approximation along with Eq. (43) determines the values of a₁ and a₂ for z<z₀ and z>z₀+δz in the forms:

$$\begin{matrix}{a}_{1} ( z ) = \{ \begin{matrix}{a}_{1} ( 0 ) + \frac{ⅈ}{2 {β}_{1}} [ {a}_{1} ( 0 ) {C}_{11} δ z + {a}_{2} ( 0 ) {C}_{12} {\int }_{{z}_{o}}^{{z}_{o} + δ z} {ⅇ}^{- {ⅈΔβz}^{′}} ⅆ {z}^{′} ] , & z > {z}_{o} + δ z \\ {a}_{1} ( 0 ) , & z \leq {z}_{o}\end{matrix} & ( 46. a ) \\ {a}_{2} ( z ) = \{ \begin{matrix}{a}_{2} ( 0 ) + \frac{ⅈ}{2 {β}_{2}} [ {a}_{2} ( 0 ) {C}_{22} δ z + {a}_{1} ( 0 ) {C}_{21} {\int }_{{z}_{o}}^{{z}_{o} + δ z} {ⅇ}^{- {ⅈΔβz}^{′}} ⅆ {z}^{′} ] , & z > {z}_{o} + δ z \\ {a}_{2} ( 0 ) , & z \leq {z}_{o}\end{matrix} & ( 46. b )\end{matrix}$$

where the integrals over z are expressible as:

$$\begin{matrix}\begin{matrix}{\int }_{{z}_{o}}^{{z}_{o} + δz} {ⅇ}^{\pm {ⅈΔβz}^{′}} ⅆ {z}^{′} = \frac{( 2 )}{( Δβ )} {ⅇ}^{\pm Δβ ( {z}_{o} + \frac{δz}{2} )} sin ( Δβ \frac{( δz )}{( 2 )} ) \\ = \frac{( 2 )}{( Δβ )} ( {Δ}_{1} \pm {ⅈΔ}_{2} )\end{matrix} \\ with \text{:} & ( 47 ) \\ {Δ}_{1} ≡ \frac{1}{2} \{ sin [ Δβ ( {z}_{o} + δ z ) - sin [ ( Δβ ) {z}_{o} ] \} \\ {Δ}_{2} ≡ - \frac{1}{2} \{ cos [ Δβ ( {z}_{o} + δ z ) - cos [ ( Δβ ) {z}_{o} ] \} & ( 48 )\end{matrix}$$

Equations (46) and (47) allow the real and imaginary parts of a, and a₂ to be evaluated, and the values of the coefficients for z>z₀+δz to be written, in analogy with Eq. (19), as the product of a modulus and a phase factor in the forms:
a₁(z)|z>₀30 δz=ρp₁e^{iθ}^{₁}, a₂(z)|z>zₒ+δz=ρ₂e^{iθ}^{₂} (49)
where ρj and θj (j=1,2) are determined by the real and imaginary parts of a₁ and a₂ through the relations ρj=\sqrt{(Reaj)²+(Ima)²},θj=tan⁻¹(Im aj/Re aj)(j=1,2). The derived formulas for a₁ and a₂, along with the assumption that the incident field at z=0 is exclusively in channel a, equivalent to the condition a₂(0)=a₁(0), can then be used to evaluate the phases θ₁ and θ₂ in Eq. (49) as:

$${θ}_{1} = {tan}^{- 1} \{ [ {C}_{11} δ z + \frac{2 {C}_{12}}{Δ β} {Δ}_{1} ] / [ 2 {β}_{1} + \frac{2 {C}_{12}}{Δ β} {Δ}_{2} ] \} \\ {θ}_{2} = {tan}^{- 1} \{ [ {C}_{22} δ z + \frac{2 {C}_{21}}{Δ β} {Δ}_{1} ] / [ 2 {β}_{2} - \frac{2 {C}_{21}}{Δ β} {Δ}_{2} ] \} \qquad ( 50 )$$

Use of the forms for a, and a₂ in Eqs. (49) in Eq. (6) expresses the field E(r, ω) for z>z₀+δz in the form:

$$E ( x , y , z ) {\vert}_{z \geq {z}_{o} + δ z} = {ρ}_{2} {ⅇ}^{i {β}_{2} z} {ⅇ}^{i {θ}_{2} } [ \frac{{ρ}_{1}}{{ρ}_{2}} {ⅇ}^{i ( {β}_{1} - {β}_{2} ) z} {ⅇ}^{i ( {θ}_{1} - {θ}_{2} )} {\tilde{ɛ}}_{1} ( x , y ) + {\tilde{ɛ}}_{2} ( x , y ) ] \qquad ( 51 )$$

By comparison of this equation with the form for E(x,y,z) in Eq. (27), and use of the argument preceding Eq. (29), the coupling length of the coupler in the presence of the perturbation is then determined as:

$${L}^{′} = \frac{π - ( {θ}_{1} - {θ}_{2} )}{( {β}_{1} - {β}_{2} )} \qquad ( 52 )$$

It is possible to draw an analytic connection between the resultant Equations (29) and (52) of the two methods of the invention. Analytic equivalence between the two methods can be derived by examining the change in the coupling length, ΔL, determined by Eq. (53.a) in the form:

$$Δ L = \frac{( {θ}_{2} - {θ}_{1} )}{( {β}_{1} - {β}_{2} )} \qquad ( 53. a )$$

with θ₁ and θ₂ defined by Eqs. (50), and alternatively determined by Eqs. (29) and (28) in the form:

$$Δ L = \frac{- ϕ}{( {β}_{1} - {β}_{2} )} = \frac{{ϕ}_{2} - {ϕ}_{1} + [ ( {β}_{1} - {β}_{2} ) - ( {β}_{1}^{′} - {β}_{2}^{′} ) ] δ z}{( {β}_{1} - {β}_{2} )} \qquad ( 53. b )$$

with ø₁ and ø₂ defined by Eqs. (26). To compare the two formulas, it helps to use the fact that the profile functions and propagation constants of the lowest modes of the perturbed and unperturbed regions of the coupler satisfy Eqs. (7), with the profile functions constrained by the orthonormality relations (δz) and the boundary conditions:

$$\underbrace{lim}_{x or y \to \pm ∞} {\tilde{ɛ}}_{l}^{′} ( x , y ) = \underbrace{lim}_{x or y \to \pm ∞} {\tilde{ɛ}}_{l} ( x , y ) = 0 \qquad ( 54 )$$

Equation (7) and the corresponding equation with εₗ and ε′ₗ replaced by ε′_{l and β′}ₗ make it possible to derive an explicit relation between the integrals Cⱼₖ defined by Eq. (44) and the propagation constants β′ⱼ and βₗ. The relation obtains by multiplication of Eq. (7) on the left by \tilde{ε}′ⱼ(x,y) and the corresponding “primed” equation on the left by \tilde{ε}ₗ (x, Y) and integration of the difference between the resulting equations over all x and y to produce the formula:

$${\int }_{- ∞}^{∞} ⅆ x {\int }_{- ∞}^{∞} ⅆ y [ {\tilde{ɛ}}_{l} {∇}_{⊥}^{2} {\tilde{ɛ}}_{j}^{′} - {\tilde{ɛ}}_{j}^{′} {∇}_{⊥}^{2} {\tilde{ɛ}}_{l} ] + \frac{{ω}^{2}}{{c}^{2}} {\int }_{- ∞}^{∞} ⅆ x {\int }_{- ∞}^{∞} ⅆ y δ ɛ ( x , y ) {\tilde{ɛ}}_{j}^{′} {\tilde{ɛ}}_{l} = ( {β}_{j}^{′2} - {β}_{l}^{2} ) {\int }_{- ∞}^{∞} ⅆ x {\int }_{- ∞}^{∞} ⅆ y {\tilde{ɛ}}_{j}^{′} {\tilde{ɛ}}_{l} , \qquad ( 55 )$$

with

$${∇}_{⊥}^{2} ≡ \frac{{\partial }^{2} }{\partial {x}^{2}} + \frac{{\partial }^{2} }{\partial {y}^{2}} ,$$

and ∂ε(x, y)=ε′(x,y)-ε(x,y). By repeated integration of the first term on the left in Eq. (55) by parts, and use of the boundary conditions (54), the integral of the first term in the integrand can be shown to equal the negative of the integral of the second term, so as to contract Eq. (55) to the relation:

$$\frac{{ω}^{2}}{{c}^{2}} {\int }_{- ∞}^{∞} ⅆ x {\int }_{- ∞}^{∞} ⅆ y δ ɛ ( x , y ) {\tilde{ɛ}}_{j}^{′} {\tilde{ɛ}}_{l} = ( {β}_{j}^{′2} - {β}_{l}^{2} ) {\int }_{- ∞}^{∞} ⅆ x {\int }_{- ∞}^{∞} ⅆ y {\tilde{ɛ}}_{j}^{′} {\tilde{ɛ}}_{l} \qquad ( 56 )$$

Use of the definition of Kⱼₗ in Eq.(14) and the expansion for \tilde{ε}′ⱼ in terms of \tilde{ε}ᵢ in Eq. (21 .b) transforms this last relation into the equation:

$$\frac{{ω}^{2}}{{c}^{2}} {\sum }_{i}^{} {κ}_{ji} {\int }_{- ∞}^{∞} ⅆ x {\int }_{- ∞}^{∞} ⅆ y δ ɛ ( x , y ) {\tilde{ɛ}}_{i} {\tilde{ɛ}}_{l} = ( {β}_{j}^{′2} - {β}_{l}^{2} ) {κ}_{jl} \qquad ( 57 )$$

which the “identity”:

$${\int }_{- ∞}^{∞} ⅆ x {\int }_{- ∞}^{∞} ⅆ y δɛ ( x , y ) {\tilde{ɛ}}_{i} {\tilde{ɛ}}_{l} = \begin{matrix}\underbrace{\int ⅆ x \int ⅆ y} \\ Region of perturbation\end{matrix} δɛ ( x , y ) {\tilde{ɛ}}_{i} {\tilde{ɛ}}_{l} \qquad ( 58 )$$

and the definition of Cᵢⱼ in Eq. (44) ftirther contract to the equality:

$${\sum }_{i} {κ}_{ji} {C}_{il} = ( {β}_{j}^{′2} - {β}_{l}^{2} ) {κ}_{jl} \qquad ( 59 )$$

It is significant that Eq. (59) represents an exact equality only under the condition that the propagation constants and profile functions, βₗ and \tilde{ε}ₗ are evaluated to the same accuracy. Under this condition, Eq. (59) connects the propagation constants βⱼ, β′ⱼ (for j=1,2) to the five independent integrals k₁₁, k₁₂, C₁₁, C₁₂(C₂₁) through a set of four equations, three of which have the forms:
k₁₁C₁₁+k₁₂C₁₂=(β′₁²-β₁²)k₁₁ (60.a)
k₂₂C₂₂+k₂₁C₁₂=(β′₂²-β₂²)k₂₂ (60.b)
k₂₁C₁₁+k₂₂C₁₂=(β′₂²-β₁²)k₂₁ (60.c)
Use of the equations allows for a direct comparison between the separate formulas in Eqs. (53)(a) and (b).

The comparison can be simplified by use of the two conditions δε<<1, (β₁-β₂)δz<<π, and the choice z₀=L₀/2(=π/2(β₁-β₂)) to replace Eqs. (53.a) and (53.b) by the respective formulas:

$$\begin{matrix}Δ L ≅ \frac{[ ( {C}_{22} / 2 {β}_{2} ) - ( {C}_{11} / 2 {β}_{1} ) ] δ z}{( {β}_{1} - {β}_{2} )} and \text{:} & ( 61. a ) \\ Δ L ≅ \frac{[ 2 {κ}_{12}^{2} ( {β}_{1}^{′} - {β}_{2}^{′} ) + ( {β}_{1} - {β}_{2} ) - ( {β}_{1}^{′} - {β}_{2}^{′} ) ] δ z}{( {β}_{1} - {β}_{2} )} & ( 61. b )\end{matrix}$$

It follows from these formulas that, within the range of values of δz for which the formulas are valid (δz≦100 μm), ΔL is strictly proportional to δz.

Subtraction of Eqs. (60.a) and (60.b) and use of relations (24.a) (or addition of the equations and use of relations (24.b)), results in the equation:
k₁₁(C₁₁-C₂₂)+2k₁₂C₁₂=k₁₁[(β′₁²-β₁²)-(β′₂²-β₂²)] (62)
which the (excellent) approximations:
β₁²-β₂²≅2β₁(β₁- β₂),β′₁²-β′₂²≅2β′₁(β′₁-β′₂)≅β₁(β′₁-β′₂) (63)
convert to the equality:

$$( {C}_{11} - {C}_{22} ) ≅ 2 {β}_{1} [ ( {β}_{1}^{′} - {β}_{2}^{′} ) - ( {β}_{1} - {β}_{2} ) ] - 2 \frac{{κ}_{12}}{{κ}_{11}} {C}_{12} \qquad ( 64 )$$

Multiplication of Eqs. (60.a) and (60.c) by k₂₁ and k₁₁ respectively, and subtraction of the resulting relations, produces the additional equation:
(k₁₁k₂₂-k₂₁k₁₂)C₁₂=(β′₁²-β′₂²)k₁₁k₂₁ (65)
which Eqs. (24) and (25) reduce to:
C₁₂=(β′₁²-β′₂²)k₁₁k₁₂≅2β₁(β′₁-β′₂)k₁₁k₁₂ (66)
Combination of this equation with Eq. (64) then establishes the result:

$$( {C}_{22} / 2 {β}_{2} ) - ( {C}_{11} / 2 {β}_{1} ) ≅ \frac{( {C}_{22} - {C}_{11} )}{2 {β}_{1}} ≅ 2 {κ}_{12}^{2} ( {β}_{1}^{′} - {β}_{2}^{′} ) + ( {β}_{1} - {β}_{2} ) - ( {β}_{1}^{′} - {β}_{2}^{′} ) \qquad ( 67 )$$

by use of which the right hand sides of Eqs. (61.a) and (61.b) are shown to be equal to within the excellent approximations in Eqs. (63). In the numerical example that follows, it is shown that the demonstrated equivalence of the two formulas for ΔL is reflected in the numerical results only to the extent that the mode profile functions and propagation constants are evaluated accurately. More significantly, comparison between the numerical values extracted from either Eqs. (53)(a) and (b) or Eqs. (61)(a) and (b) demonstrates that the “corner corrected” propagation constants calculated for a rectangular geometry coupler are inaccurate.

Evaluation of the change in coupling length produced by δε by use of formula (61 .b) requires a determination of the propagation constants and profile functions of the supermodes of the waveguide in both the trimmed and untrimmed regions of the coupler. In contrast, evaluation of ΔL by use of the alternative formula (61. a) requires evaluation of only the profile functions and propagation constants of the unperturbed coupler. To determine the required functions in both cases, separation of variables is used to construct a solution of Maxwell's wave equation for the profile functions. The solution incorporates the continuity conditions at the boundaries of the waveguide channels a and b perpendicular to the two transverse directions \hat{x} and ŷ, but introduces an inaccuracy in the exterior “corner” regions of the waveguide that leads to an error in both the propagation constants and profile functions of the modes. This error is maximized if there is a lack of symmetry in the trimmed region of the coupler

The geometry of the coupler produced by the method of the invention, which is best illustrated by FIG. 6, has a number of advantages. First, the symmetry of the geometry serves to minimize the error in the computed values of the propagation constants resulting from the inaccuracy in the mode field functions in the outer regions of the coupler. The advantage follows from the symmetry with respect to the two mode field functions exhibited in the formula for ΔL in Eq. (3), which is absent in the expression for the change in the coupling length in the case of a perturbation not symmetric with respect to the central axis of the coupler. In particular, it is a consequence of the symmetry with respect to the labels 1 and 2 in Eq. (3) that the “corner field corrections”, required to correct the mode fields 1 and 2, subtract from one another in the integrand of Eq. (3), and partially cancel the corrections to the denominator of the equation, so as to eliminate the necessity for corrections to the formula for ΔL in the case of the geometry of FIG. 6. The consequence makes possible an accurate analytic evaluation of the value of ΔL resulting from a given change in index of refraction, allowing for precise design of the perturbation required to produce a desired result.

Another advantage of the method of the present invention is that the symmetry of the perturbation with respect to the central axis of the coupler results in positive or negative values for ΔL dependent on the sign of δn, so as to allow for either an increase or decrease in the coupling length of the coupler. Still another advantage of the symmetry of the geometry is that it results in a complete transfer of power between the channels of the coupler at the value of z corresponding to the coupling length of the coupler. In contrast, in the case of a perturbation that introduces an asymmetry in the channels, the transfer of power can never be complete.

Another advantage provided by the coupler geometry formed by the method of the present invention is that the location of the perturbation in the geometry, external to the channels of the coupler, leaves the region of perturbation accessible to controls, which allow the output of the coupler to be readily tuned. The location of the perturbation in the geometry, external to the channels of the coupler, also minimizes the loss in the coupler induced by the perturbation. In addition, when L_{T} of FIG. 6 is of a length such that it extends beyond the evanescent fields of the waveguides in the x direction, the change in coupling length becomes independent of L_{T}. Moreover, when the thickness h is thick enough to extend beyond the evanescent fields in the y direction, the change in coupling length also becomes independent of h. The proposed symmetric trimming/tuning geometry defined by FIG. 6 also has the advantage with respect to the unsymmetric geometry illustrated in FIG. 3 in that it allows the perturbation to produce a change in the coupling length of the coupler that is independent of the coordinate zₒ at which the perturbation is positioned.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. An optical waveguide coupling device comprising:
at least two optical channel waveguides functioning as at least one of power dividing and directional coupling elements, with the energy in one channel of the device being caused to transfer to another channel within a distance of travel within said one channel that is equal to a coupling length L; and
a region of perturbation of length δz in communication with said optical channel waveguides, said region of perturbation having an effective index of refraction that causes a change in said coupling length by an amount ΔL in such a way that the profile of the refractive index in the altered region is symmetric about the direction of propagation of a light signal, whereby said changed coupling length provides a method of controlling the transfer of energy between said channel waveguides.

2. The coupling device according to claim 1 wherein said optical channel waveguides are planar waveguide devices and further wherein said optical channel waveguides are included withina photonic integrated circuit.

3. The coupling device according to claim 2 wherein said region of perturbation surrounds said optical channel waveguides.

4. The coupling device according to claim 2 wherein said region of perturbation extends between said optical channel waveguides.

5. The coupling device according to claim 4 further including a device for changing said effective index of refraction for said region of perturbation between said optical channel waveguides.

6. The coupling device according to claim 5 wherein said device for changing said index of refraction provides a variable change in said index of refraction whereby the transfer of energy between said waveguides is tuned.

7. The coupling device according to claim 6 further including an electric field generator that is operative to alter said index of refraction by applying a symmetric electric field to said region of perturbation.

8. The coupling device according to claim 6 further including a magnetic field generator that is operative to alter said index of refraction by applying a symmetric magnetic field to said region of perturbation.

9. The coupling device according to claim 6 further including a piezoelectric device that is operative to alter said index of refraction by applying a force field to said region of perturbation such that said region is deformed by the stress applied by said force.

10. The coupling device according to claim 4 further including a constant change in said effective index of refraction for said region of perturbation between said optical channel waveguides whereby the transfer of energy between said waveguides is trimmed.

11. The coupling device according to claim 10 wherein said constant change in said effective index of refraction includes at least one of forming an aperture through said region of perturbation and implanting ions within said region of perturbation.

12. The coupling device according to claim 4 wherein said controlling of said coupling length L of the coupling device is optimized by a symmetry of geometry in a region of control with said change in said coupling length L being independent of a coordinate zₒ at which said region of perturbation is located.

13. The coupling device according to claim 4 wherein said controlling of said coupling length L of the coupling device negates the necessity for corner field corrections to propagation constants and profile functions of the device while also allowing for an accurate design of said perturbation region required to produce a change in the coupling length of a desired value.

14. The coupling device according to claim 4 wherein said controlling of said coupling length L of the coupling device provides one of an increase and decrease in said coupling length of the device that is dependent upon the sign of the change in said effective refractive index n produced by the said perturbation.

15. The coupling device according to claim 4 wherein said controlling of said coupling length L of the device provides a complete transfer of energy between said channels when said coupling length L equal to a coordinate zₒ at which said region of perturbation is located.

16. The coupling device according to claim 6 wherein said device for changing said index of refraction is accessible to external controls allowing tuning that is under feedback control.

17. The coupling device according to claim 16 wherein said controlling of said coupling length L of the device minimizes loss in the device produced by the perturbation.

18. A method for coupling optical waveguides consisting of the steps of:
(a) providing at least two or more optical channel waveguides functioning as at least one of power dividing and directional coupling elements, with the energy in one channel of the device being transferred to another channel after a distance of travel that is within a coupling length L, the waveguide devices in communication with a region of perturbation of length δz, the region of perturbation having an effective index of refraction that is symmetric about the direction of propagation of the light within the channels; and
(b) changing the effective index of refraction of the region of perturbation to cause a change in the coupling length of the device by an amount ΔL, whereby the changed coupling length provides a method of controlling the transfer of energy between the waveguides.

19. The method according to claim 18 wherein the optical channel waveguides provided in step (a) are planar waveguide devices and further wherein the optical channel waveguides are included within a photonic integrated circuit.

20. The method of claim 10 wherein the change in the effective index of refraction in step (b) is variable, whereby the optical channel waveguides are tuned.

21. The method of claim 10 wherein the change in the effective index of refraction in step (b) is constant, whereby the optical channel waveguides are trimmed.

22. The coupling device according to claim 2 wherein said waveguides are covered by a cladding material and further wherein said cladding material includes said region of perturbation.

23. The coupling device according to claim 22 wherein said cladding material has a refractive index n₀ that is less than a refractive index n₀ of said waveguides and further wherein said perturbation region has a refractive index n₂ that is greater than n₀.

24. The coupling device according to claim 23 wherein n₂ is less than n₁.

25. The coupling device according to claim 23 wherein n₂ is greater than n₁.

26. The coupling device according to claim 23 wherein n₂ is equal to n₁.
